(19) United States
(12) Patent Application Publication
(10) Pub. No.: US 2025/0357027 A1
(43) Pub. Date: Nov. 20, 2025

(54) Series Architecture Output Driver for Input-Output with Constant Step

(71) Applicant: Microchip Technology Incorporated, Chandler, AZ (US)

(72) Inventor: Nadir Fridi, Marseille (FR)

(73) Assignee: Microchip Technology Incorporated, Chandler, AZ (US)

(21) Appl. No.: 19/086,448

(22) Filed: Mar. 21, 2025

Related U.S. Application Data
(60) Provisional application No. 63/647,309, filed on May 14, 2024.

(51) Int. Cl. H01C 1/16; G06F 13/20

(52) U.S. Cl. CPC H01C 1/16; G06F 13/20; G06F 2213/40

(57) ABSTRACT

An apparatus includes a network of switch-resistor pairs connected between a voltage level and an output pad or pin, and a control circuit to enable or disable respective switches of given switch-resistor pairs of the network. A given switch-resistor pair includes a switch and a resistor connected in parallel. Enablement of the switch is to cause current to flow through the switch and the resistor in parallel. Disablement of the switch of the given switch-resistor pair is to cause current to flow through the resistor and not the switch. A resistance of the resistor is less than half of an on-resistance of the switch.

### FIELD OF THE INVENTION

The present disclosure relates to input/output (I/O) interfaces of electronic devices and, more particularly, to a series architecture output driver for input-output with constant step.

### BACKGROUND

I/O drivers may provide functionality to output a logic one or logic zero value on an output pin or pad in between various electronic devices, or within such electronic devices. For example, serial I/O may be used to output data values to a memory or externally from a transceiver or microcontroller.

In high-speed I/O applications, the inventor of examples of the present disclosure has discovered that an output impedance value should be maintained in order to correctly transmit data. However, the inventor of examples of the present disclosure has also discovered that I/O driver impedance may be sensitive to process, voltage, and temperature (PVT) conditions. Consequently, adjustment of output impedance may be performed, and the adjustment may depend on particular PVT conditions so as to maintain a given output impedance value.

Other implementations of adjusting output impedance may include a network of transistors connected in parallel to one another. The network may be connected between VDD and an output pin or pad, or between ground and the output pin or pad. The individual transistors of the network of may be selectively enabled or disabled so as to cause a given amount of impedance for current to flow to or from the output pin or pad for the output value. When connected between VDD and an output pin or pad may, the network may be made up of P-type metal-oxide-semiconductor transistors. When connected between ground and an output pin or pad may, the network may be made up of N-type metal-oxide-semiconductor transistors. Given a quantity×legs of a given network, the network may be capable of providing a quantity 2\hat{ }×different impedance values.

However, inventors of examples of the present disclosure have discovered various limitations of this approach of using a network of transistors connected in parallel. During the transient state of such transistors, wherein a transistor goes from being enabled to disabled, or from disabled to enabled, the current-voltage relationship between Ids and Vgs is not linear, as would be the case if a resistor instead of a transistor were used. Inventors of examples of the present disclosure have also discovered that output impedance for such networks changes greatly as more legs of the network are enabled, wherein large steps in impedance may happen for the first few legs that are enabled or disabled, while much smaller steps in impedance may happen for the last few legs that are enabled or disabled. Again, this presents a non-linear relationship between current and voltage with respect to impedance. Furthermore, inventors of examples of the present disclosure have discovered that the on resistance of a given transistor, given as R_{ON}, may vary according to as Vds/Ids, and thus resistance of a given transistor may thus depend upon Ids, which in turn depends upon the number and size of the enabled legs, and further that for a given PVT case, the R_{ON} may vary according to the particular set of legs that are enabled or disabled. Inventors of examples of the present disclosure have discovered that a more linear relationship between current and voltage resulting in impedance may be more successful in maintaining an impedance value during high-speed I/O.

Inventors of examples of the present disclosure have discovered solutions that may address one or more of these issues identified in the field of I/O communication.

### BRIEF DESCRIPTION OF THE DRAWINGS

FIG. 1 is an illustration of an apparatus for a series architecture output driver for input-output with constant step, according to examples of the present disclosure.

FIG. 2 is an illustration of an example calibration system for controlling output impedance, according to examples of the present disclosure.

FIG. 3 is an illustration of a method for driving a series architecture output driver for input-output with constant step, according to examples of the present disclosure.

FIGS. 4A and 4B are an illustration of a method for calibrating a series architecture output driver for input-output with constant step, according to examples of the present disclosure.

### DETAILED DESCRIPTION

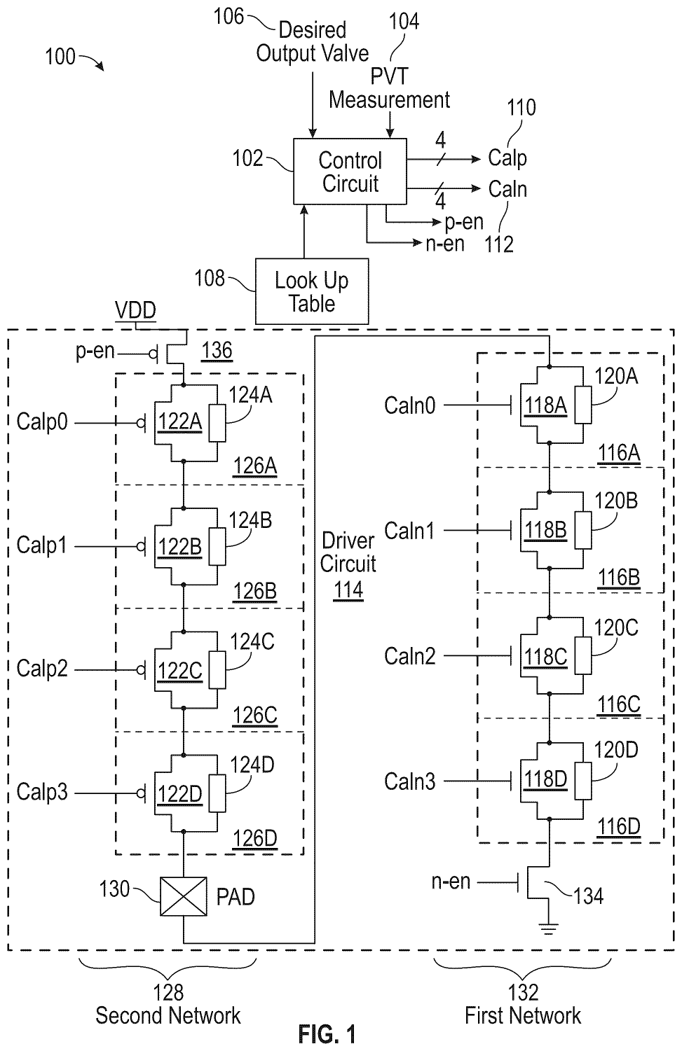

FIG. 1 is an illustration of an apparatus 100 for a series architecture output driver for input-output with constant step, according to examples of the present disclosure.

Apparatus 100 may be implemented within any suitable context, such as within a microcontroller, transceiver, serial interface, or other suitable electronic device. For example, apparatus 100 may be implemented as a part of a high-speed serial I/O device within a larger electronic device.

Apparatus 100 may be configured to apply a desired output value 106 on an output pin or pad 130. Apparatus 100 may be configured to output any suitable value as an output on output pin or pad 130. For example, apparatus 100 may be configured to output a logical one or logical zero value as an output on output pin or pad 130. The logical one or logical zero value may have any suitable corresponding output voltage value, such as +5 or +3.3 V for a logical one value, and 0, −3.3, or −5 V for a logical zero value.

Apparatus 100 may be configured to output a value on output pin or pad 130 with a predetermined level of impedance. The predetermined level of impedance may be a relatively minimal amount of impedance, wherein the output value may be output on output pin or pad 130 with such a relatively minimal amount of impedance.

Apparatus 100 may include a driver circuit 110. Driver circuit 110 may include more or fewer elements than shown in FIG. 1. For example, apparatus 100 may include a control circuit 102. In some examples, control circuit 102 may be included in driver circuit 110, while in other examples, control circuit 102 may be outside of but communicatively coupled to driver circuit 110.

Control circuit 102 may be implemented in any suitable manner, such as by analog circuitry, digital circuitry, instructions for execution by a processor, field programable gate array, application specific interface circuit, programmable logic device, microcontroller, or any suitable combination thereof.

Control circuit 102 may receive any suitable number and kind of inputs, such as a desired output value 106, a measurement 104 of present PVT conditions, and information stored in a memory such as a look-up table 108. The information stored in the memory such as look-up table 108 may include given impedance values that are to be used in outputting the desired output value 106 for a given PVT condition.

Driver circuit 110 may be implemented by one or more networks of switch-resistor pairs. In one example, a first network 132 of switch-resistor pairs 116 may be used to output a logic low value on output pin or pad 130. In another example, a second network 128 of switch-resistor pairs 126 may be used to output a logic high value on output pin or pad 130.

A first end of first network 132 may be electrically connected to pad 130. A second end of first network 132 may be electrically connected to ground or another suitable low level voltage value. A first end of second network 128 may be electrically connected to a voltage source, given as VDD. A second end of second network 128 may be electrically connected to pad 130.

First network 132 of switch-resistor pairs 116 may be enabled to output a logic low value on output pin or pad 130 through operation of a switch 134. Switch 134 may be implemented in any suitable manner, such as by a N-channel metal-oxide semiconductor (NMOS) transistor, or any other suitable transistor or switch. Switch 134 may be driven or controlled by control circuit 102. Control circuit 102 may issue the signal n_en which may turn switch 134 on or off. When switch 134 is turned on, first network 132 of switch-resistor pairs 116 may be enabled to output a logic low value on output pin or pad 130. Switch 134 may be connected between the rest of first network 132 and ground or another suitable low level voltage value.

Second network 128 of switch-resistor pairs 126 may be enabled to output a logic high value on output pin or pad 130 through operation of a switch 132. Switch 132 may be implemented in any suitable manner, such as by a P-channel metal-oxide semiconductor (PMOS) transistor, or any other suitable transistor or switch. Switch 132 may be driven or controlled by control circuit 102. Control circuit 102 may issue the signal p_en which may turn switch 132 on or off. When switch 132 is turned on, second network 128 of switch-resistor pairs 126 may be enabled to output a logic high value on output pin or pad 130.

Any suitable number and kind of switch-resistor pairs 116 may be included in first network 128. The instances of switch-resistor pairs 116 may be implemented in a same or different manner. A given instance of switch-resistor pairs 116 may include a respective switch 118 and resistor 120. Although referred to as a resistor 120, any suitable resistive element may be used. The instances of switch-resistor pairs 116 may each include a same or differently implemented switch 118. Switch 118 may be implemented as, for example, a NMOS transistor, or any other suitable transistor or switch. The instances of switch-resistor pairs 116 may each include a same or differently implemented resistor 120. The resistance values of resistors 120 may be the same or may be different.

Any suitable number and kind of switch-resistor pairs 126 may be included in second network 128. The instances of switch-resistor pairs 126 may be implemented in a same or different manner. A given instance of switch-resistor pairs 126 may include a respective switch 122 and resistor 124. Although referred to as a resistor 124, any suitable resistive element may be used. The instances of switch-resistor pairs 126 may each include a same or differently implemented switch 122. Switch 122 may be implemented as, for example, a PMOS transistor, or any other suitable transistor or switch. The instances of switch-resistor pairs 126 may each include a same or differently implemented resistor 124. The resistance values of resistors 124 may be the same or may be different.

Each of switch-resistor pairs 126 and switch-resistor pairs 116 may be configured to allow the respective switch to selectively bypass its corresponding resistor. When the respective switch is enabled or turned on, current may flow through the switch rather than through the resistor. The res

When a given one of first network 132 or second network 128 is enabled, control circuit 102 may selectively enable a permutation of the switch-resistor pairs therein. For example, control circuit 102 may enable selected ones of first network 132 with caln 112, which may include four control signals routed to the gates of switches of switch-resistor pairs 116. Control circuit 102 may enable selected ones of second network 128 with calp 110, which may include four control signals routed to the gates of switches of switch-resistor pairs 126. These control signals may be given as caln0 . . . caln3 and calp0 . . . calp3, for example.

When a given switch-resistor pair, such as one of switch-resistor pairs 126 or switch-resistor pairs 116, is enabled, the path through the respective switch (such as switch 122 or 118) may provide an alternate path for current flowing through the given switch-resistor pair. In one example, the alternate path of current through the respective switch may not be an exclusive alternative for current flowing through the given switch-resistor pair, but is in addition to the path for current to flow through the respective resistor. Thus, when a given switch-resistor pair is enabled through enabling of the respective switch therein, current may flow through both the respective switch and the resistor therein. When a given switch-resistor pair is disabled through disabling of the respective switch therein, current may flow only through the resistor therein. Accordingly, enabling a given switch-resistor pair may slightly lessen the effective impedance of the given switch resistor pair.

The amount by which enabling a given switch-resistor pair may lessen the effective impedance of the given switch resistor pair may be dependent upon the ON resistance of the switch therein, given as RON. Accordingly, different granularity of a specific amount of impedance that will be applied to the output on pad 130 may be achieved through selection of different sizes of switches in switch-resistor pairs 126, 116.

In some examples, the respective resistance value of a given resistor in a given switch-resistor pair may be significantly less than the RON of the corresponding switch of the switch-resistor pair. That is, given a resistor Rx and a switch denoted as calX,

$${R}_{x} ≪ RO {N}_{calx}$$

This may allow the connection of transistors of switch-resistor pairs 126 or 116 to be connected in series without considering the respective V_{DS} variations of such transistors. Furthermore, this may allow the on-resistance variations of the transistors to be ignored. Thus,

$${R}_{x} ‖ {RON}_{Calx} \approx {R}_{x} ‖ ( {RON}_{Calx} + Δ RO {N}_{Calx} ) ,$$

wherein the impedance of Rx, RONCalx are significantly less that ΔRON_{Calx}.

The sizing of switches 122, 118 may thus affect the respective resistance thereof. The larger that a given switch 122, 118 is, the larger its RON value may be. The larger that its RON value is, the less impedance that the corresponding switch-resistor pair 126, 116 will have when the given switch is enabled.

For example, the resistance of resistors 124 may add up to 200 ohms. Similarly, the resistance of resistors 120 may add up to 200 ohms. In various examples, the sum total of the resistance of resistors 120 may match the sum total of the resistance of resistors 124.

Switch 122A may be sized so as to have an RON that, when enabled, the impedance of switch-resistor pair 126A is the resistance value of resistor 124A less n ohms. In various examples, switch 120A may be also sized so as to have an RON that, when enabled, the impedance of switch-resistor pair 116A is the resistance value of resistor 120A less n ohms. Switches 122A and 120A may be implemented with a same size and RON value.

Switch 122B may be sized so as to have an RON that, when enabled, the impedance of switch-resistor pair 126B is the resistance value of resistor 124B less 2*n ohms. In various examples, switch 120B may be also sized so as to have an RON that, when enabled, the impedance of switch-resistor pair 116B is the resistance value of resistor 120B less 2*n ohms. Switches 122B and 120B may be implemented with a same size and RON value.

Switch 122C may be sized so as to have an RON that, when enabled, the impedance of switch-resistor pair 126C is the resistance value of resistor 124C less 3*n ohms. In various examples, switch 120C may be also sized so as to have an RON that, when enabled, the impedance of switch-resistor pair 116C is the resistance value of resistor 120C less 3*n ohms. Switches 122C and 120C may be implemented with a same size and RON value.

Switch 122D may be sized so as to have an RON that, when enabled, the impedance of switch-resistor pair 126D is the resistance value of resistor 124D less 4*n ohms. In various examples, switch 120D may be also sized so as to have an RON that, when enabled, the impedance of switch-resistor pair 116D is the resistance value of resistor 120D less 4*n ohms. Switches 122D and 120D may be implemented with a same size and RON value.

These are reproduced again in the following chart:

| | Effective Resistance when |
|---|---|
| Switch | Switch Enabled |
| 122A, 120A | (R ∥ RON) = R − n |
| 122B, 120B | (R ∥ RON) = R − 2*n |
| 122C, 120C | (R ∥ RON) = R − 3*n |
| 122D, 120D | (R ∥ RON) = R − 4*n |

The value of n may be selected to give effective granularity for a given sum total of resistance values of resistors 124 or 120, in combination with possible variation of PVT values. For example, if the sum of the resistance values of resistors 124 or 120 is 200 ohms, n may be selected as 8 ohms. In another example, n may be selected as 1 ohm. In such examples, the following RON values may be used to implement switches 122, 118:

| | | | | n = 8 | | n = 1 | |
|---|---|---|---|---|---|---|---|
| Resistor | R value | Switch | (R ∥ RON) | 8 | RON value | 1 | RON value |
| 124A/120A | 50 | 122A/118A | R − n | 42 | 262.50 | 49 | 2450.00 |
| 124B/120B | 50 | 122B/118B | R − 2n | 34 | 106.25 | 48 | 1200.00 |
| 124C/120C | 50 | 122C/118C | R − 3n | 26 | 54.17 | 47 | 783.33 |
| 124D/120D | 50 | 122D/118D | R − 4n | 18 | 28.13 | 46 | 575.00 |

In an n=8 implementation as shown above, the following permutations of impedance output values for signals on output pad 120 may be possible with different code values for calp 110 or caln 112:

| Code: calp \| | calp3 \| | calp2 \| | calp1 \| | calp0 \| | Total |
|---|---|---|---|---|---|
| caln | caln3 | caln2 | caln1 | caln0 | Resistance |
| 1 | 0 | 0 | 0 | 0 | 200 |
| 2 | 0 | 0 | 0 | 1 | 192 |
| 3 | 0 | 0 | 1 | 0 | 184 |
| 4 | 0 | 0 | 1 | 1 | 176 |
| 5 | 0 | 1 | 0 | 0 | 176 |
| 6 | 0 | 1 | 0 | 1 | 168 |
| 7 | 0 | 1 | 1 | 0 | 160 |
| 8 | 0 | 1 | 1 | 1 | 152 |
| 9 | 1 | 0 | 0 | 0 | 168 |
| 10 | 1 | 0 | 0 | 1 | 160 |
| 11 | 1 | 0 | 1 | 0 | 152 |
| 12 | 1 | 0 | 1 | 1 | 144 |
| 13 | 1 | 1 | 0 | 0 | 144 |
| 14 | 1 | 1 | 0 | 1 | 136 |
| 15 | 1 | 1 | 1 | 0 | 128 |
| 16 | 1 | 1 | 1 | 1 | 120 |

If the resistance values of resistors 124, 120 are not the same, more permutations may be available.

The control circuit 102 may be configured to selectively enable or disable switch-resistor pairs in the first network 132 and the second network 128 using the caln 112 and calp 110 signals, respectively. By selectively enabling or disabling these switch-resistor pairs, the control circuit 102 may adjust the output impedance of the apparatus 100 at the output pad or pin 130.

The apparatus 100 may be configured to maintain the output impedance within approximately 10% of a target value. For example, if the target impedance value is 50 ohms, the apparatus 100 may maintain the actual output impedance between 45 ohms and 55 ohms. This precise control of output impedance may be achieved through the selective enabling and disabling of switch-resistor pairs in the first network 132 and the second network 128 based on the desired output value 106 and other factors such as process, voltage, and temperature variations.

The control circuit 102 may be configured to process inputs and generate control signals for the driver circuit 114. The control circuit 102 may receive a PVT measurement input 104 and a desired output value 106. The PVT measurement input 104 may provide information about process, voltage, and temperature conditions affecting the apparatus 100. The desired output value 106 may indicate the intended logical value to be output on the output pad or pin 130.

The control circuit 102 may utilize a lookup table 108 to determine appropriate control signals based on the received inputs. The lookup table 108 may contain pre-calculated values for generating control signals under various conditions. The control circuit 102 may access the lookup table 108 to retrieve values corresponding to the current PVT measurement input 104 and desired output value 106.

Based on the information from the lookup table 108, the control circuit 102 may generate control signals calp 110 and caln 112. The calp 110 signal may be used to control the second network 128, while the caln 112 signal may be used to control the first network 132. These control signals may determine which switch-resistor pairs in the respective networks are enabled or disabled, thereby adjusting the output impedance of the apparatus 100.

The control circuit 102 may be configured to calibrate the output impedance based on a comparison with a reference rather than directly using PVT measurements. This calibration process may involve comparing the output impedance of the driver circuit 114 to a reference impedance value. The control circuit 102 may then adjust the calp 110 and caln 112 signals to bring the output impedance closer to the desired reference value.

The control circuit 102 may be configured to perform calibration periodically during refresh periods when the apparatus 100 is not transmitting or receiving data through the output pad or pin 130. This periodic calibration may help maintain accurate output impedance despite changing operating conditions. The frequency of calibration may be determined based on any suitable factors, such as the stability of the operating environment or the precision requirements of the application.

The first network 132 of the apparatus 100 may include any suitable number and kind of switch-resistor pairs connected in series between the output pad or pin 130 and ground. In some examples, the first network 132 may include four switch-resistor pairs: a first switch-resistor pair 116A, a second switch-resistor pair 116B, a third switch-resistor pair 116C, and a fourth switch-resistor pair 116D.

Each switch-resistor pair in the first network 132 may include a switch and a resistor connected in parallel. For example, the first switch-resistor pair 116A may include a first switch 118A connected in parallel with a first resistor 120A. Similarly, the second switch-resistor pair 116B may include a second switch 118B connected in parallel with a second resistor 120B, the third switch-resistor pair 116C may include a third switch 118C connected in parallel with a third resistor 120C, and the fourth switch-resistor pair 116D may include a fourth switch 118D connected in parallel with a fourth resistor 120D.

The first network 132 may be connected to ground through an enable switch 134. The enable switch 134 may be controlled by the control circuit 102 to enable or disable the entire first network 132. When the enable switch 134 is closed, the first network 132 may be activated to potentially output a logic low value on the output pad or pin 130.

The switches 118A, 118B, 118C, and 118D in the switch-resistor pairs may be individually controlled by the control circuit 102 through the caln 112 signals. When a switch is enabled (closed), current may flow through both the switch and its parallel resistor. When a switch is disabled (open), current may flow only through the parallel resistor.

The resistance of each resistor in a switch-resistor pair may be substantially less than the on-resistance of the corresponding switch. For example, the resistance of the first resistor 120A may be substantially less than the on-resistance of the first switch 118A. This configuration may allow the first network 132 to maintain a more consistent impedance across different operating conditions.

By selectively enabling or disabling the switches in the switch-resistor pairs, the control circuit 102 may adjust the overall impedance of the first network 132. This adjustment may allow the apparatus 100 to maintain a target output impedance on the output pad or pin 130 when outputting a logic low value, even as process, voltage, or temperature conditions vary.

The control circuit 102 may determine which switches to enable or disable based on the desired output value 106 and information from the lookup table 108. The lookup table 108 may contain pre-calculated values for generating appropriate caln 112 signals under various conditions, allowing the control circuit 102 to quickly adjust the impedance of the first network 132 as needed.

The second network 128 may be connected to the voltage source through an enable switch 136. The enable switch 136 may be controlled by the control circuit 102 to enable or disable the entire second network 128. When the enable switch 136 is closed, the second network 128 may be activated to potentially output a logic high value on the output pad or pin 130.

By selectively enabling or disabling the switches in the switch-resistor pairs, the control circuit 102 may adjust the overall impedance of the second network 128. This adjustment may allow the apparatus 100 to maintain a target output impedance on the output pad or pin 130 when outputting a logic high value, even as process, voltage, or temperature conditions vary.

The control circuit 102 may determine which switches to enable or disable based on the desired output value 106 and information from the lookup table 108. The lookup table 108 may contain pre-calculated values for generating appropriate calp 110 signals under various conditions, allowing the control circuit 102 to quickly adjust the impedance of the second network 128 as needed.

In contrast to the first network 132, which may be used to output a logic low value, the second network 128 may be used to output a logic high value. The structure and operation of the two networks may be similar, with the main difference being their connection to different voltage levels (ground for the first network 132 and VDD for the second network 128) and their control signals (caln 112 for the first network 132 and calp 110 for the second network 128).

The operation of apparatus 100 may involve the control circuit 102 using the calp 110 and caln 112 signals to control the first network 132 and the second network 128, respectively. This control may allow apparatus 100 to adjust the output impedance at the output pad or pin 130 based on process, voltage, and temperature (PVT) conditions and the desired output value 106.

The control circuit 102 may be configured to receive the PVT measurement input 104 and the desired output value 106. Based on these inputs, the control circuit 102 may access the lookup table 108 to determine appropriate control signals for the driver circuit 114. The lookup table 108 may contain pre-calculated values for generating control signals under various conditions.

For outputting a logic low value, the control circuit 102 may enable the first network 132 by activating the enable switch 134. The control circuit 102 may then use the caln 112 signals to selectively enable or disable the switches in the switch-resistor pairs of the first network 132. For example, the control circuit 102 may enable the first switch 118A, the second switch 118B, the third switch 118C, or the fourth switch 118D in any suitable combination to achieve the desired output impedance. The switch for second network may be deactivated when outputting a logic high value.

Similarly, for outputting a logic high value, the control circuit 102 may enable the second network 128 by activating the enable switch 136. The control circuit 102 may then use the calp 110 signals to selectively enable or disable the switches in the switch-resistor pairs of the second network 128. The control circuit 102 may enable the first switch 122A, the second switch 122B, the third switch 122C, or the fourth switch 122D in any suitable combination to achieve the desired output impedance.

The selective enabling and disabling of switches in the switch-resistor pairs may allow the control circuit 102 to fine-tune the output impedance of apparatus 100. When a switch in a switch-resistor pair is enabled, current may flow through both the switch and its parallel resistor, effectively reducing the impedance of that pair. When a switch is disabled, current may flow only through the parallel resistor, maintaining a higher impedance for that pair.

The control circuit 102 may be configured to adjust the output impedance dynamically based on changing PVT conditions. For example, if the PVT measurement input 104 indicates a change in temperature, the control circuit 102 may access the lookup table 108 to determine a new combination of switch states that may maintain the desired output impedance under the new conditions.

The control circuit 102 may also be configured to maintain approximately equal output impedance when outputting logic high and logic low values. This may be achieved by appropriately sizing the switches and resistors in the first network 132 and the second network 128, and by using complementary control strategies for the caln 112 and calp 110 signals. The approximately equal impedance may be within, for example, ten percent of a desired impedance.

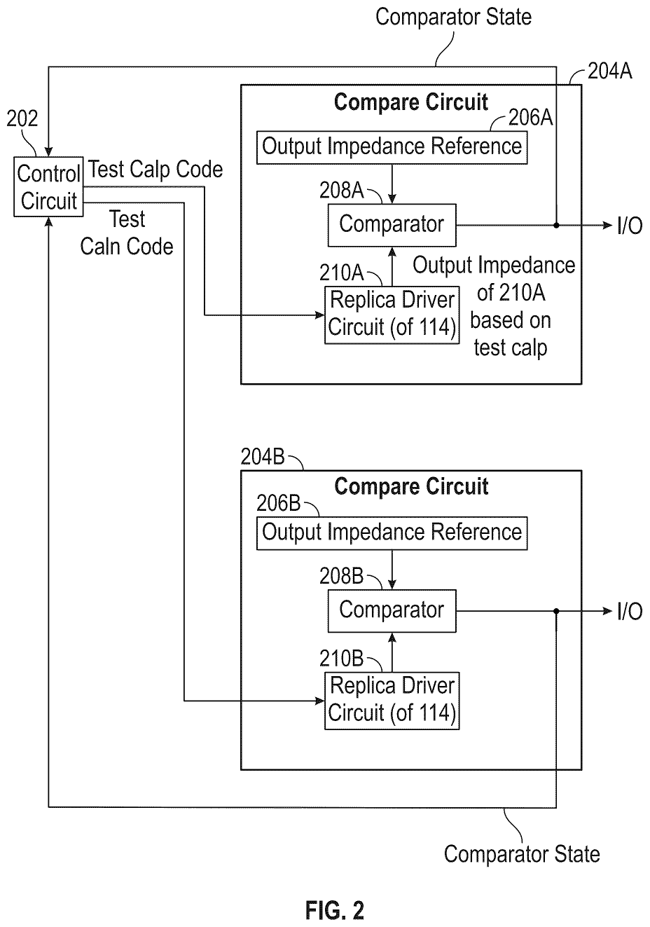

FIG. 2 is an illustration of a calibration system for maintaining precise control over the output impedance. The calibration system may be configured to work in conjunction with the control circuit 102 and the driver circuit 114 to ensure that the output impedance at the output pad or pin 130 remains within a target range despite variations in process, voltage, and temperature conditions.

The calibration system may include a control circuit 202, which may be implemented separately from or as part of the control circuit 102. The control circuit 202 may be configured to manage the calibration process and generate appropriate control signals based on the results of impedance comparisons.

In some examples, the calibration system may include a first compare circuit 204A and a second compare circuit 204B. These compare circuits may be configured to perform impedance comparisons between replica driver circuits and reference impedance values. The first compare circuit 204A and the second compare circuit 204B may operate in parallel, allowing for simultaneous calibration of different aspects of the driver circuit 114.

The calibration system may utilize replica driver circuits that mimic the behavior of the driver circuit 114. These replica driver circuits may be implemented with similar switch-resistor pair configurations as found in the first network 132 and the second network 128. By using replica driver circuits, the calibration system may perform impedance adjustments without interfering with the normal operation of the driver circuit 114.

In some examples, the calibration system may include one replica driver circuit. In other examples, the calibration system may include two replica driver circuits, which may allow for simultaneous calibration of both the first network 132 and the second network 128. The use of multiple replica driver circuits may enable faster calibration and more precise control over the output impedance.

The control circuit 202 may be configured to apply test calibration codes to the replica driver circuits. These test calibration codes may be similar to the calp 110 and caln 112 signals used to control the switch-resistor pairs in the driver circuit 114. By adjusting these test calibration codes and comparing the resulting impedances to reference values, the calibration system may determine codes for maintaining the desired output impedance.

The results of the impedance comparisons performed by the first compare circuit 204A and the second compare circuit 204B may be used by the control circuit 202 to update the lookup table 108. This updated information may then be used by the control circuit 102 to generate appropriate calp 110 and caln 112 signals for controlling the driver circuit 114, ensuring that the output impedance at the output pad or pin 130 remains within the target range.

The calibration system may operate periodically or on-demand, depending on the specific requirements of the apparatus 100. By regularly performing calibration, the apparatus 100 may maintain consistent output impedance across varying operating conditions, enhancing the reliability and performance of the high-speed I/O interface. The calibration circuit may operate based on a determination of changed PVT measurements.

The first compare circuit 204A and the second compare circuit 204B may each include any suitable components for performing impedance comparisons. In some examples, the first compare circuit 204A may include a first comparator 208A and a first replica driver circuit 210A. Similarly, the second compare circuit 204B may include a second comparator 208B and a second replica driver circuit 210B.

The first replica driver circuit 210A and the second replica driver circuit 210B may be configured to mimic the behavior of the driver circuit 114. Each replica driver circuit may include any suitable number and kind of switch-resistor pairs, similar to those found in the first network 132 and the second network 128. For example, the first replica driver circuit 210A may include switch-resistor pairs that correspond to the first switch-resistor pair 116A, the second switch-resistor pair 116B, the third switch-resistor pair 116C, and the fourth switch-resistor pair 116D of the first network 132. Similarly, the second replica driver circuit 210B may include switch-resistor pairs that correspond to the first switch-resistor pair 126A, the second switch-resistor pair 126B, the third switch-resistor pair 126C, and the fourth switch-resistor pair 126D of the second network 128.

The control circuit 202 may be configured to apply test calibration codes to the first replica driver circuit 210A and the second replica driver circuit 210B. These test calibration codes may be similar to the caln 112 and calp 110 signals used to control the switch-resistor pairs in the driver circuit 114. By applying different test calibration codes, the control circuit 202 may adjust the impedance of the replica driver circuits.

The first comparator 208A may be configured to compare the output impedance of the first replica driver circuit 210A against an output impedance reference 206A. Similarly, the second comparator 208B may be configured to compare the output impedance of the second replica driver circuit 210B against an output impedance reference 206B. The output impedance references 206A and 206B may be implemented using any suitable reference circuit or value that represents the desired target impedance for the driver circuit 114.

When the control circuit 202 applies a test calibration code to the first replica driver circuit 210A, the resulting output impedance may be compared to the output impedance reference 206A by the first comparator 208A. The first comparator 208A may generate a comparison result indicating whether the output impedance of the first replica driver circuit 210A matches or is closer to the output impedance reference 206A than a previous test.

Similarly, when the control circuit 202 applies a test calibration code to the second replica driver circuit 210B, the resulting output impedance may be compared to the output impedance reference 206B by the second comparator 208B. The second comparator 208B may generate a comparison result indicating whether the output impedance of the second replica driver circuit 210B matches or is closer to the output impedance reference 206B than a previous test.

The control circuit 202 may be configured to receive the comparison results from the first comparator 208A and the second comparator 208B. Based on these comparison results, the control circuit 202 may determine whether the applied test calibration codes have improved the match between the replica driver circuit impedances and their respective reference impedances. If an improvement is detected, the control circuit 202 may update the lookup table 108 with the new calibration codes.

By using two separate compare circuits, the calibration system may perform simultaneous impedance comparisons for both the high-side (corresponding to the second network 128) and low-side (corresponding to the first network 132) of the driver circuit 114. This parallel operation may allow for faster calibration and more precise control over the output impedance of the apparatus 100.

The first replica driver circuit 210A and the second replica driver circuit 210B may be designed to closely match the characteristics of the driver circuit 114. This may include using similar transistor sizes, resistor values, and layout techniques. By closely matching the replica driver circuits to the actual driver circuit, the calibration system may provide more accurate impedance adjustments that account for variations in process, voltage, and temperature conditions.

The control circuit 202 may be configured to perform a series of impedance comparisons using different test calibration codes. For each comparison, the control circuit 202 may adjust the test calibration codes based on the previous comparison results. This iterative process may continue until the output impedances of the replica driver circuits match or are within an acceptable range of their respective output impedance references.

Once the control circuit 202 determines the optimal calibration codes based on the impedance comparisons, these codes may be used to update the lookup table 108. The updated lookup table 108 may then be used by the control circuit 102 to generate appropriate caln 112 and calp 110 signals for controlling the driver circuit 114, ensuring that the output impedance at the output pad or pin 130 remains within the target range.

The calibration process for apparatus 100 may be designed to maintain precise control over the output impedance at the output pad or pin 130. The control circuit 202 may be configured to initiate the calibration process using the last known calibration code as a starting point, rather than beginning from a default state. This approach may allow for faster convergence on the optimal calibration settings, particularly when operating conditions have not changed significantly since the last calibration.

The control circuit 202 may be configured to apply the last used calibration code to the first replica driver circuit 210A and the second replica driver circuit 210B. These replica driver circuits may be designed to mimic the behavior of the driver circuit 114, including the first network 132 and the second network 128. By applying the last used calibration code, the control circuit 202 may establish a baseline for the current output impedance.

The first comparator 208A may be configured to compare the output impedance of the first replica driver circuit 210A against the output impedance reference 206A. Similarly, the second comparator 208B may be configured to compare the output impedance of the second replica driver circuit 210B against the output impedance reference 206B. The comparison results may be provided to the control circuit 202, which may use this information to determine whether the current calibration code is still appropriate or if adjustments are needed.

If the comparison results indicate that the output impedance matches the reference values within an acceptable tolerance, the control circuit 202 may determine that no further calibration is necessary. In this case, the current calibration code may be maintained and used to update the lookup table 108.

However, if the comparison results indicate a mismatch between the output impedance and the reference values, the control circuit 202 may be configured to adjust the calibration code incrementally. The control circuit 202 may apply the adjusted calibration code to the replica driver circuits and perform another comparison. This process may be repeated iteratively until the output impedance matches the reference values within the acceptable tolerance.

The calibration process may be integrated with the operation of apparatus 100 in any suitable manner. For example, the control circuit 202 may be configured to initiate calibration periodically during refresh periods when the apparatus 100 is not actively transmitting or receiving data through the output pad or pin 130. This approach may allow for regular adjustments to maintain optimal output impedance without interfering with normal operation.

Additionally, the control circuit 202 may be configured to trigger calibration in response to any suitable events or conditions, such as significant changes in temperature or voltage as detected by the PVT measurement input 104. This adaptive approach may ensure that the apparatus 100 maintains optimal performance across varying operating conditions.

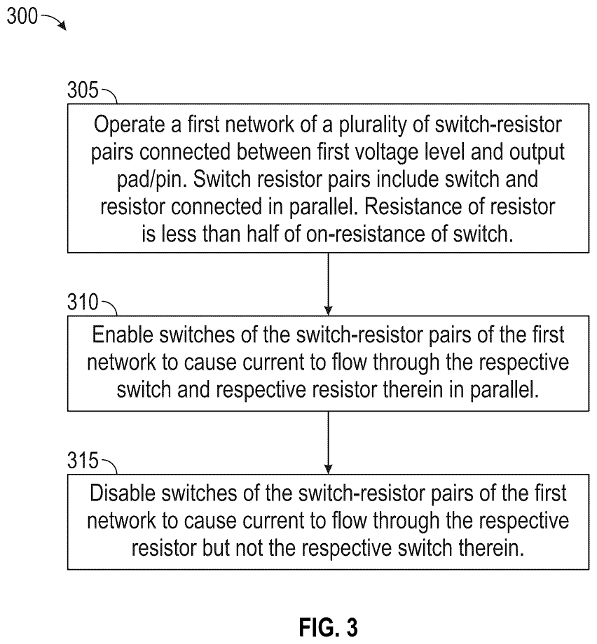

FIG. 3 is an illustration of a method 300 for operating an output driver for input-output with a constant step, according to examples of the present disclosure.

Method 300 may be performed by any suitable apparatus, such as by the elements of FIGS. 1-2. For example, method 300 may be performed by control circuit 102 and driver circuit 114. Method 300 may include more or fewer steps than shown. Moreover, steps of method 300 may be optionally repeated, omitted, performed in parallel or recursively, or in a different order than shown. Method 300 may begin at any suitable step, such as 305.

At 305, a first network of a plurality of switch-resistor pairs connected between first voltage level and output pad or pin may be operated. Switch resistor pairs may include a respective switch and a respective resistor connected in parallel. A resistance of the respective resistor may be substantially less, such as less than half, of the on-resistance of respective switch.

At 310, switches of the switch-resistor pairs may be enabled to cause current to flow from the respective switch and resistor therein in parallel.

At 315, switches of the switch-resistor pairs may be disabled to cause current flow through the respective resistor but not the respective switch therein.

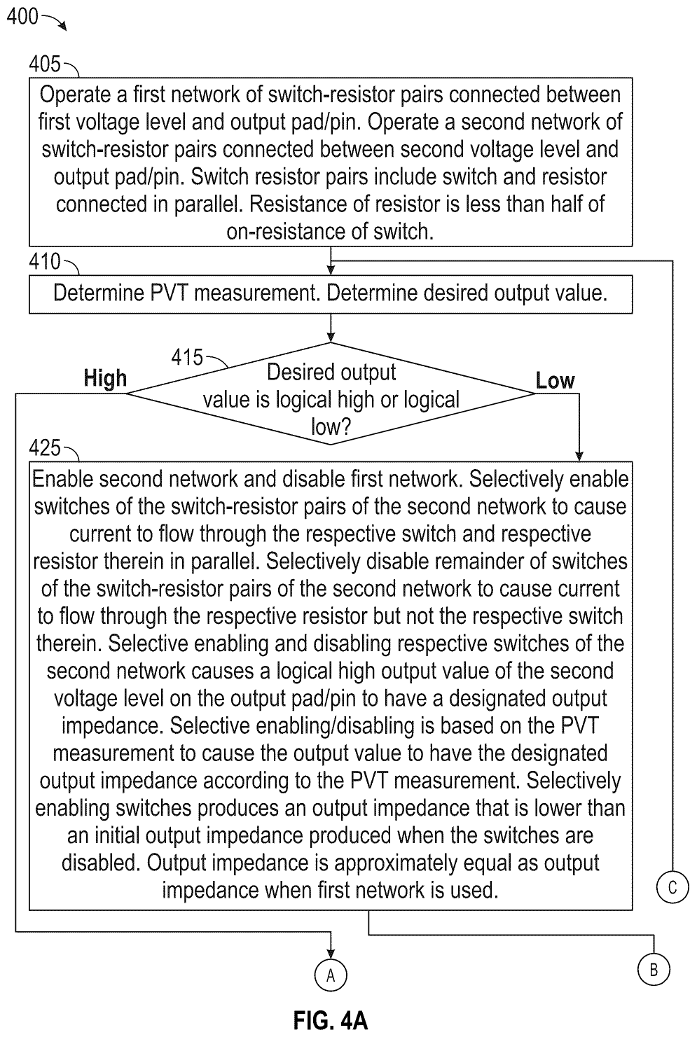

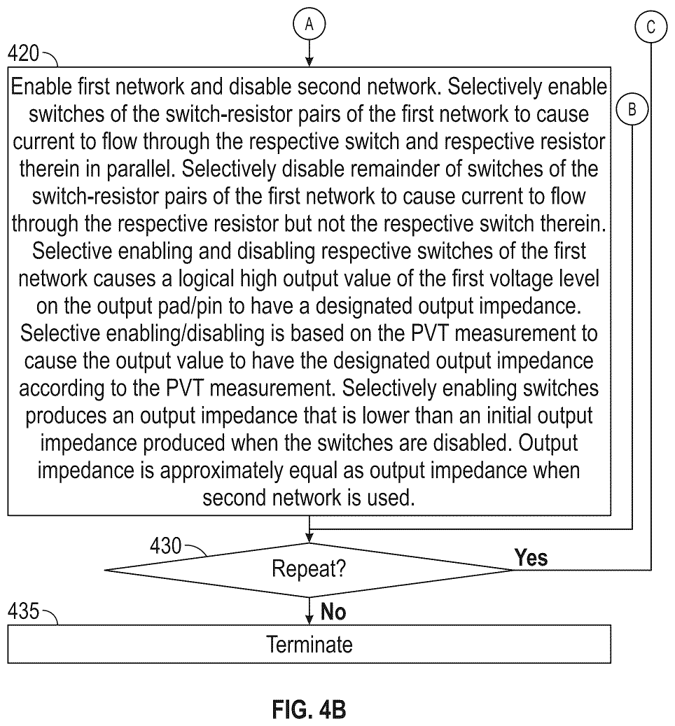

FIGS. 4A and 4B are an illustration of a method 400 for operating an output driver for input-output with a constant step, according to examples of the present disclosure.

Method 400 may be performed by any suitable apparatus, such as by the elements of FIGS. 1-2. For example, method 400 may be performed by control circuit 102 and driver circuit 114. Method 400 may include more or fewer steps than shown. Moreover, steps of method 400 may be optionally repeated, omitted, performed in parallel or recursively, or in a different order than shown. Method 400 may begin at any suitable step, such as 405.

At 405, a first network of a plurality of switch-resistor pairs connected between first voltage level and an output pad or pin may be operated. A second network of a plurality of switch-resistor pairs connected between a second voltage level and the output pad or pin may also be operated. Switch resistor pairs may include a respective switch and a respective resistor connected in parallel. A resistance of the respective resistor may be substantially less, such as less than half, of the on-resistance of respective switch.

At 410, a PVT measurement may be determined. A desired output value may be determined.

At 415, it may be determined whether the desired output value is a logic high or a logic low value. If the desired output value is a logic high value, method 400 may proceed to 420. Otherwise, if the desired output value is a logic low value, method 400 may proceed to 425.

At 420, the first network may be enabled and the second network may be disabled. Switches of the switch-resistor pairs of the first network may be selectively enabled to cause current to flow through the respective switch and respective resistor therein in parallel. A remainder of the switches of the switch-resistor pairs of the first network may be disabled to cause current to flow through the respective resistor but not the respective switch therein. Selective enabling and disabling respective switches of the first network may cause a logical high output value of the first voltage level on the output pad or pin to have a designated output impedance. Selective enabling or disabling of given switches may be based on the PVT measurement to cause the output value to have the designated output impedance according to the PVT measurement. Selectively enabling switches may be produce an output impedance that is lower than an initial output impedance produced when the switches are disabled. Output impedance may be approximately equal as output impedance when the second network is enabled.

At 425, the first network may be disabled and the second network may be enabled. Switches of the switch-resistor pairs of the second network may be selectively enabled to cause current to flow through the respective switch and respective resistor therein in parallel. A remainder of the switches of the switch-resistor pairs of the second network may be disabled to cause current to flow through the respective resistor but not the respective switch therein. Selective enabling and disabling respective switches of the second network may cause a logical low output value of the first voltage level on the output pad or pin to have a designated output impedance. Selective enabling or disabling of given switches may be based on the PVT measurement to cause the output value to have the designated output impedance according to the PVT measurement. Selectively enabling switches may be produce an output impedance that is lower than an initial output impedance produced when the switches are disabled. Output impedance may be approximately equal as output impedance when the first network is enabled

Examples of the present disclosure may include an apparatus with a first network of a plurality of switch-resistor pairs, where the plurality of switch-resistor pairs of the first network may be connected in series, and the first network of the plurality of switch-resistor pairs may be connected between a first voltage level and a terminal. The apparatus may include a control circuit that may be configured to enable or disable respective switches of given switch-resistor pairs of the network of the plurality of switch-resistor pairs. A given switch-resistor pair of the first network of the plurality of switch-resistor pairs may include a switch and a resistor connected in parallel. Enablement of the switch of the given switch-resistor pair may cause current to flow through the switch and the resistor in parallel. Disablement of the switch of the given switch-resistor pair may cause current to flow through the resistor and not the switch. A resistance of the resistor may be less than an on-resistance of the switch. The first network of the plurality of switch-resistor pairs, control circuit, switches, and resistors may be implemented in any suitable manner, such as with analog circuitry, digital circuitry, an FPGA, an ASIC, instructions for execution by a processor, or any suitable combination thereof.

In combination with any of the above examples, the control circuit may be configured to selectively enable or disable respective switches of given switch-resistor pairs of the network of the plurality of switch-resistor pairs to maintain a target output impedance value on the terminal.

In combination with any of the above examples, the control circuit may be configured to selectively enable or disable respective switches of given switch-resistor pairs of the network of the plurality of switch-resistor pairs to cause an output value on the terminal to have a designated output impedance to accommodate a variance of process, voltage, or temperature.

In combination with any of the above examples, the control circuit may be configured to: selectively enable respective switches of given switch-resistor pairs of the network of the plurality of switch-resistor pairs to produce a first output impedance that may be lower than an initial output impedance, the initial output impedance produced when the respective switches of the plurality of switch-resistor pairs may be disabled; or selectively disable respective switches of given switch-resistor pairs of the network of the plurality of switch-resistor pairs to produce a second output impedance that may be higher than the initial output impedance.

In combination with any of the above examples, the first voltage level may include a voltage value to be produced on the terminal when the control circuit enables the first network of the plurality of switch-resistor pairs.

In combination with any of the above examples, the apparatus may include a second network of a plurality of switch-resistor pairs, where the plurality of switch-resistor pairs of the second network may be connected in series, the second network of the plurality of switch-resistor pairs may be connected between a second voltage level and the terminal. The control circuit may be configured to enable the first network of the plurality of switch-resistor pairs to produce the first voltage level as a target output voltage on the terminal, the target output voltage a logical one value. The control circuit may be configured to enable the second network of the plurality of switch-resistor pairs to produce the second voltage level as the target output voltage on the terminal, the target output voltage a logical zero value. The output impedance when outputting the logical one value or the logical zero value may be approximately equal.

In combination with any of the above examples, respective switches of the first network of the plurality of switch-resistor pairs may be sized according to a predetermined amount of reduced resistance when a given switch-resistor pair may be enabled, and a first predetermined amount of reduced resistance when a first switch-resistor pair may be enabled may be greater than a second predetermined amount reduced resistance when a second switch-resistor pair may be enabled.

Examples of the present disclosure may include a method involving operating a first network of a plurality of switch-resistor pairs, where the plurality of switch-resistor pairs of the first network may be connected in series, the first network of the plurality of switch-resistor pairs connected between a first voltage level and a terminal, where a given switch-resistor pair of the first network of the plurality of switch-resistor pairs may include a switch and a resistor connected in parallel. The method may include enabling respective switches of given switch-resistor pairs of the network of the plurality of switch-resistor pairs to cause current to flow through a respective switch and a respective resistor of the given switch-resistor pair in parallel. The method may include disabling respective switches of given switch-resistor pairs of the network of the plurality of switch-resistor pairs to cause current to flow through the respective resistor and not the respective switch of the given switch-resistor pair. A resistance of the respective resistor may be less than an on-resistance of the respective switch.

In combination with any of the above examples, the method may include selectively enabling or disabling respective switches of given switch-resistor pairs of the network of the plurality of switch-resistor pairs to maintain a target output impedance value on the output pad to preserve signal integrity.

In combination with any of the above examples, the method may include selectively enabling or disabling respective switches of given switch-resistor pairs of the network of the plurality of switch-resistor pairs to cause an output value on the terminal to have a designated output impedance to accommodate a variance of process, voltage, or temperature.

In combination with any of the above examples, the method may include: selectively enabling switches of given switch-resistor pairs of the network of the plurality of switch-resistor pairs to produce an output impedance that may be lower than an initial output impedance, the initial output impedance produced when the respective switches of given switch-resistor pairs of the network of the plurality of switch-resistor pairs may be disabled; or selectively disabling switches of given switch-resistor pairs of the network of the plurality of switch-resistor pairs to produce an output impedance that may be higher than the initial output impedance.

In combination with any of the above examples, the first voltage level may include a voltage value to be produced on the terminal when enabling the first network of the plurality of switch-resistor pairs.

In combination with any of the above examples, the method may include: operating a second network of a plurality of switch-resistor pairs, the second network of the plurality of switch-resistor pairs may be connected between a second voltage level and the terminal; enabling the first network of the plurality of switch-resistor pairs to produce the first voltage level as a target output voltage on the terminal, the target output voltage a logical one value; and enabling the second network of the plurality of switch-resistor pairs to produce the second voltage level as the target output voltage on the terminal, the target output voltage a logical zero value; where the output impedance when outputting the logical one value or the logical zero value may be approximately equal.

In combination with any of the above examples, respective switches of the first network of the plurality of switch-resistor pairs may be sized according to a predetermined amount of reduced resistance when a given switch-resistor pair may be enabled, and a first predetermined amount of reduced resistance when a first switch-resistor pair may be enabled may be greater than a second predetermined amount reduced resistance when a second switch-resistor pair may be enabled.

Examples of the present disclosure may include an apparatus with a switch driver circuit, comprising: a first array of switch-resistor pairs connected in series between a first voltage level and a terminal; and a second array of switch-resistor pairs connected in series between a second voltage level and a terminal; where the switch-resistor pairs of the first and second arrays may include a first leg and a second leg connected in parallel, the first leg including a switch and the second leg including a resistor, where the resistor may have a resistance that may be substantially less than an on-resistance of the switch. The apparatus may include a control circuit to: determine a target output voltage value to be issued on the terminal, the target output voltage value may include a logical high value or a logical low value; based on a determination to output the logical high value, enable the first array of switch-resistor pairs to output the first voltage level on the terminal as the logical high value; based on a determination to output the logical low value, enable the second array of switch-resistor pairs to output the first voltage level on the terminal as the logical low value; based on a target output impedance of output the target output value on the terminal, issue a plurality of control signals to the first array or the second array of switch-resistor pairs to selective enable or disable switch-resistor pairs therein to cause a target output impedance. The switch driver circuit, control circuit, switches, and resistors may be implemented in any suitable manner, such as with analog circuitry, digital circuitry, an FPGA, an ASIC, instructions for execution by a processor, or any suitable combination thereof.

In combination with any of the above examples, the control circuit may be configured to: calibrate the switch driver circuit to maintain the target output impedance based on a comparison with a reference; issue the plurality of control signals to the first array or the second array of switch-resistor pairs to selectively enable or disable switch-resistor pairs therein to cause the target output impedance based on a comparison with the reference.

In combination with any of the above examples, the control circuit may be configured to issue the plurality of control signals to the first array or the second array of switch-resistor pairs to selectively enable switch-resistor pairs therein to reduce an initial output impedance to the target output impedance.

In combination with any of the above examples, the control circuit may be configured to issue the plurality of control signals to the first array or the second array of switch-resistor pairs to selectively disable switch-resistor pairs therein to increase an initial output impedance to the target output impedance.

In combination with any of the above examples, the plurality of control signals as issued to the first array of switch-resistor pairs may cause the target output impedance when the target output voltage may be routed through the first array of switch-resistor pairs; and the plurality of control signals as issued to the second array of switch-resistor pairs may cause the target output impedance when the target output voltage may be routed through the second array of switch-resistor pairs.

In combination with any of the above examples, a first switch of a first switch-resistor pair of the first array of switch-resistor pairs may have a first size, the first size may cause a first predetermined amount of reduced resistance when the first switch may be enabled; a second switch of a second switch-resistor pair of the first array of switch-resistor pairs may have a second size, the second size may cause a second predetermined amount of reduced resistance when the second switch may be enabled; and the first predetermined amount of reduced resistance may be less than the second predetermined amount of reduced resistance.

Although examples have been described above, other variations and examples may be made from this disclosure without departing from the spirit and scope of these examples.

We claim:

1. An apparatus, comprising:
a first network of a plurality of switch-resistor pairs, wherein the plurality of switch-resistor pairs of the first network are connected in series, the first network of the plurality of switch-resistor pairs to be connected between a first voltage level and a terminal; and
a control circuit configured to enable or disable respective switches of given switch-resistor pairs of the network of the plurality of switch-resistor pairs;
wherein:
a given switch-resistor pair of the first network of the plurality of switch-resistor pairs includes a switch and a resistor connected in parallel;
enablement of the switch of the given switch-resistor pair is configured to cause current to flow through the switch and the resistor in parallel;
disablement of the switch of the given switch-resistor pair is configured to cause current to flow through the resistor and not the switch; and
a resistance of the resistor is less than an on-resistance of the switch.

2. The apparatus of claim 1, wherein the control circuit is configured to selectively enable or disable respective switches of given switch-resistor pairs of the network of the plurality of switch-resistor pairs to maintain a target output impedance value on the terminal.

3. The apparatus of claim 1, wherein the control circuit is configured to selectively enable or disable respective switches of given switch-resistor pairs of the network of the plurality of switch-resistor pairs to cause an output value on the terminal to have a designated output impedance to accommodate a variance of process, voltage, or temperature.

4. The apparatus of claim 1, wherein the control circuit is configured to:
selectively enable respective switches of given switch-resistor pairs of the network of the plurality of switch-resistor pairs to produce a first output impedance that is lower than an initial output impedance, the initial output impedance produced when the respective switches of the plurality of switch-resistor pairs are disabled; or
selectively disable respective switches of given switch-resistor pairs of the network of the plurality of switch-resistor pairs to produce a second output impedance that is higher than the initial output impedance.

5. The apparatus of claim 1, wherein the first voltage level includes a voltage value to be produced on the terminal when the control circuit enables the first network of the plurality of switch-resistor pairs.

6. The apparatus of claim 1, comprising a second network of a plurality of switch-resistor pairs, wherein the plurality of switch-resistor pairs of the second network are connected in series, the second network of the plurality of switch-resistor pairs to be connected between a second voltage level and the terminal, wherein:
the control circuit is configured to enable the first network of the plurality of switch-resistor pairs to produce the first voltage level as a target output voltage on the terminal, the target output voltage a logical one value;
the control circuit is configured to enable the second network of the plurality of switch-resistor pairs to produce the second voltage level as the target output voltage on the terminal, the target output voltage a logical zero value; and
the output impedance when outputting the logical one value or the logical zero value are approximately equal.

7. The apparatus of claim 1, wherein respective switches of the first network of the plurality of switch-resistor pairs are sized according to a predetermined amount of reduced resistance when a given switch-resistor pair is enabled, and a first predetermined amount of reduced resistance when a first switch-resistor pair is enabled is greater than a second predetermined amount reduced resistance when a second switch-resistor pair is enabled.

8. A method, comprising:
operating a first network of a plurality of switch-resistor pairs, wherein the plurality of switch-resistor pairs of the first network are connected in series, the first network of the plurality of switch-resistor pairs connected between a first voltage level and a terminal, wherein a given switch-resistor pair of the first network of the plurality of switch-resistor pairs includes a switch and a resistor connected in parallel;
enabling respective switches of given switch-resistor pairs of the network of the plurality of switch-resistor pairs to cause current to flow through a respective switch and a respective resistor of the given switch-resistor pair in parallel; and
disabling respective switches of given switch-resistor pairs of the network of the plurality of switch-resistor pairs to cause current to flow through the respective resistor and not the respective switch of the given switch-resistor pair;
wherein a resistance of the respective resistor is less than an on-resistance of the respective switch.

9. The method of claim 8, comprising selectively enabling or disabling respective switches of given switch-resistor pairs of the network of the plurality of switch-resistor pairs to maintain a target output impedance value on the output pad to preserve signal integrity.

10. The method of claim 8, comprising selectively enabling or disabling respective switches of given switch-resistor pairs of the network of the plurality of switch-resistor pairs to cause an output value on the terminal to have a designated output impedance to accommodate a variance of process, voltage, or temperature.

11. The method of claim 8, comprising:
selectively enabling switches of given switch-resistor pairs of the network of the plurality of switch-resistor pairs to produce an output impedance that is lower than an initial output impedance, the initial output impedance produced when the respective switches of given switch-resistor pairs of the network of the plurality of switch-resistor pairs are disabled; or
selectively disabling switches of given switch-resistor pairs of the network of the plurality of switch-resistor pairs to produce an output impedance that is higher than the initial output impedance.

12. The method of claim 8, wherein the first voltage level includes a voltage value to be produced on the terminal when enabling the first network of the plurality of switch-resistor pairs.

13. The method of claim 8, comprising:
operating a second network of a plurality of switch-resistor pairs, the second network of the plurality of switch-resistor pairs to be connected between a second voltage level and the terminal;
enabling the first network of the plurality of switch-resistor pairs to produce the first voltage level as a target output voltage on the terminal, the target output voltage a logical one value; and
enabling the second network of the plurality of switch-resistor pairs to produce the second voltage level as the target output voltage on the terminal, the target output voltage a logical zero value;
wherein the output impedance when outputting the logical one value or the logical zero value are approximately equal.

14. The method of claim 8, wherein respective switches of the first network of the plurality of switch-resistor pairs are sized according to a predetermined amount of reduced resistance when a given switch-resistor pair is enabled, and a first predetermined amount of reduced resistance when a first switch-resistor pair is enabled is greater than a second predetermined amount reduced resistance when a second switch-resistor pair is enabled.

15. An apparatus, comprising:
a switch driver circuit, comprising:
a first array of switch-resistor pairs connected in series between a first voltage level and an terminal; and
a second array of switch-resistor pairs connected in series between a second voltage level and an terminal;
wherein the switch-resistor pairs of the first and second arrays include a first leg and a second leg connected in parallel, the first leg including a switch and the second leg including a resistor, wherein the resistor has a resistance that is substantially less than an on-resistance of the switch;
a control circuit to:
determine a target output voltage value to be issued on the terminal, the target output voltage value to include a logical high value or a logical low value;
based on a determination to output the logical high value, enable the first array of switch-resistor pairs to output the first voltage level on the terminal as the logical high value;
based on a determination to output the logical low value, enable the second array of switch-resistor pairs to output the first voltage level on the terminal as the logical low value;
based on a target output impedance of output the target output value on the terminal, issue a plurality of control signals to the first array or the second array of switch-resistor pairs to selective enable or disable switch-resistor pairs therein to cause a target output impedance.

16. The apparatus of claim 15, wherein the control circuit is configured to:
calibrate the switch driver circuit to maintain the target output impedance based on a comparison with a reference;
issue the plurality of control signals to the first array or the second array of switch-resistor pairs to selectively enable or disable switch-resistor pairs therein to cause the target output impedance based on a comparison with the reference.

17. The apparatus of claim 15, wherein the control circuit is configured to issue the plurality of control signals to the first array or the second array of switch-resistor pairs to selectively enable switch-resistor pairs therein to reduce an initial output impedance to the target output impedance.

18. The apparatus of claim 15, wherein the control circuit is configured to issue the plurality of control signals to the first array or the second array of switch-resistor pairs to selectively disable switch-resistor pairs therein to increase an initial output impedance to the target output impedance.

19. The apparatus of claim 15, wherein:
the plurality of control signals as issued to the first array of switch-resistor pairs are to cause the target output impedance when the target output voltage is routed through the first array of switch-resistor pairs; and
the plurality of control signals as issued to the second array of switch-resistor pairs are to cause the target output impedance when the target output voltage is routed through the second array of switch-resistor pairs.

20. The apparatus of claim 15, wherein:
a first switch of a first switch-resistor pair of the first array of switch-resistor pairs has a first size, the first size to cause a first predetermined amount of reduced resistance when the first switch is enabled;
a second switch of a second switch-resistor pair of the first array of switch-resistor pairs has a second size, the second size to cause a second predetermined amount of reduced resistance when the second switch is enabled; and
the first predetermined amount of reduced resistance is less than the second predetermined amount of reduced resistance.
